(19) United States
(12) Patent Application Publication
(10) Pub. No.: US 2026/0267535 A1
(43) Pub. Date: Sep. 10, 2026

(54) TECHNIQUES FOR PERFORMING TENSOR OPERATIONS USING A NEAR-MEMORY PROCESSOR

(71) Applicant: NVIDIA CORPORATION, Santa Clara, CA (US)

(72) Inventors: Rangharajan VENKATESAN, San Jose, CA (US); Benjamin Andrew KELLER, Oakland, CA (US); Thierry TAMBE, Cambridge, MA (US)

(21) Appl. No.: 19/070,236

(22) Filed: Mar. 4, 2025

(51) Int. Cl. G06F 3/06

(52) U.S. Cl. CPC G06F 3/0625; G06F 3/0659; G06F 3/0673

(57) ABSTRACT

One embodiment of a method for processing data includes receiving, by a first processor, first data from a first request transmitted by a second processor to a memory; performing, by the first processor, at least part of a tensor operation based on the first data and second data stored in the memory to generate a first output; and writing, by the first processor, the first output to the memory, where the first processor performs processing closer to the memory than the second processor performs processing.

### BACKGROUND

### Field of the Various Embodiments

The various embodiments relate generally to computer science and computer processors and, more specifically, to techniques for performing tensor operations using a near-memory processor.

### Description of the Related Art

Processors, such as central processing units (CPU) and graphics processing units (GPUs), typically include multiple processing units with circuitry for handling different types of computations. For example, some processors include artificial intelligence (AI) accelerators that speed up AI tasks, such as deep learning and neural network processing. To perform computations, processing units fetch data from memory, process the data, and then store the processed results in the memory or forward the results for use by other processing units.

To fetch data from memory for processing, a processing unit, such as an AI accelerator, issues a read request for the data. The read request is sent to a memory hierarchy that can include different types of storage, such as cache memory, main memory, and long-term storage. The memory hierarchy returns the data in a read response. To store data in memory after processing has been performed, the processing unit issues a write request that includes the data to the memory hierarchy.

One drawback of the above approach for processing data is that the processing units, such as AI accelerators, need to repeatedly fetch data from memory via read requests before the data can be processed, and data that has been processed also needs to be stored back in the memory via write requests. Moving data back and forth between the processing units and memory takes time due to the lengths of the data paths between the processing units and the memory, creating delays that are referred to as latency. Moving data back and forth between the processing units and memory across the data paths can also consume significant amounts of power, making the processors less efficient and generating heat.

As the foregoing illustrates, what is needed in the art are more effective techniques for processing data in processors.

### SUMMARY

One embodiment of the present disclosure sets forth a computer-implemented method for processing data. The method includes receiving, by a first processor, first data from a first request transmitted by a second processor to a memory. The method further includes performing, by the first processor, at least part of a tensor operation based on the first data and second data stored in a memory to generate a first output. In addition, the method includes writing, by the first processor, the first output to the memory. The first processor performs processing closer to the memory than the second processor performs processing.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that, with the disclosed techniques, computations including tensor operations are performed, at least in part, using a near-memory processor that performs processing closer to a memory than an AI accelerator performs processing. As a result, data movements between the AI accelerator and the memory can be reduced, improving the performance of a computing device that includes the AI accelerator and the near-memory processor and reducing energy consumption. The disclosed techniques also permit the near-memory processor to store and retrieve data across multiple memory banks within a memory bank cluster of the memory simultaneously, which can increase overall data transfer rates. In addition, the disclosed techniques permit the near-memory processor to automatically synthesize zeroes that are used for padding, without requiring the zeroes to be stored in memory, thereby saving storage space, power, and access latency. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 illustrates a system-on-chip that can be included in the parallel processing subsystem of FIG. 1, according to various embodiments;

FIG. 5 illustrates how a neural network can be executed on the system-on-chip of FIG. 4, according to various embodiments;

FIG. 6 is a more detailed illustration of the near-memory processor of FIG. 4, according to various embodiments;

FIG. 7 is a more detailed illustration of the memory requester of FIG. 6, according to various embodiments;

FIG. 8 illustrates how the near-memory processor of FIG. 4 can perform a depthwise convolution with padded data, according to various embodiments;

FIG. 9 illustrates how the near-memory processor of FIG. 4 can perform a shuffle operation using variable bandwidth requests, according to various embodiments;

FIG. 10 illustrates how the AI accelerator and the near-memory processor of FIG. 4 can perform a LayerNorm operation, according to various embodiments; and

FIG. 11 is a flow diagram of method steps for performing computations using a near-memory processor, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for performing tensor-level operations using a near-memory processor (NMP). In some embodiments, the NMP includes an element-wise addition (EADD) unit, an element-wise multiply (EMUL) unit, a configuration decoder, a configuration memory, a memory requester, and a memory responder. In operation, the NMP receives input data from a request, such as an output write request, that is issued by an AI accelerator to a global scratchpad memory. The input data is routed to the EADD unit, the EMUL unit, or the configuration decoder, depending on whether the input data is associated with an EADD, an EMUL, or other more complex operations, respectively.

If the input data is routed to the EADD unit or the EMUL unit, then the EADD unit or the EMUL unit issues a read request to the global scratchpad for data that is required to perform an EADD or an EMUL operation, respectively. In some embodiments, the read request can use the same memory address as an output write request that was issued by the AI accelerator and from which the input data was obtained. Using the input data and data that is returned by the global scratchpad in a read response as two operands, the EADD unit or the EMUL unit performs the EADD or the EMUL operation, respectively, to generate an output, and the NMP transmits a write request to write the output back to the same memory address in the global scratchpad. Accordingly, output requests from the AI accelerator can trigger, for an EADD or an EMUL, read, modify, and write operations to a particular memory location in the global scratchpad.

In addition to read, modify, and write operations for EADD and EMUL operations, the NMP also permits read, modify, and write operations for more complex tensor-level operations. When the input data is associated with a more complex operation, then the input data is routed to the configuration decoder. The configuration decoder performs decoding of input data by using a table stored in the configuration memory to determine an NMP configuration that includes the types of operations to perform and a sequence of addresses in the global scratchpad that need to be accessed. Based on the NMP configuration, the memory requester generates one or more read requests to read from the sequence of addresses in the global scratchpad that are indicated by the NMP configuration. In some embodiments, the memory requester is padding-aware and does not issue requests to read data from memory addresses corresponding to padding. Instead, the memory responder synthesizes zeroes to use in computations for such memory addresses. In some embodiments, the memory requester utilizes variable bandwidth to access data from a single memory bank or multiple memory banks of the global scratchpad that are clustered together in a memory bank cluster. Data that is returned in one or more responses to read request(s) from the memory requester are processed by one or more of the computational units in the memory responder. For example, the intermediate results for a LayerNorm operation can be processed to compute a LayerNorm output. Then, the NMP issues one or more write requests to write the output of the computational unit(s) to the global scratchpad, including to a single memory bank or multiple memory banks of a memory bank cluster.

The techniques for performing tensor-level operations using a NMP have many real-world applications. For example, the techniques can be used to perform tensor-level operations using a NMP within a processor, such as a graphics processing unit (GPU) or a central processing unit (CPU).

The above examples are not in any way intended to be limiting. As persons skilled in the art will appreciate, as a general matter, the techniques for performing tensor-level operations using a NMP described herein can be implemented anywhere that tensor operations are required or useful.

### System Overview

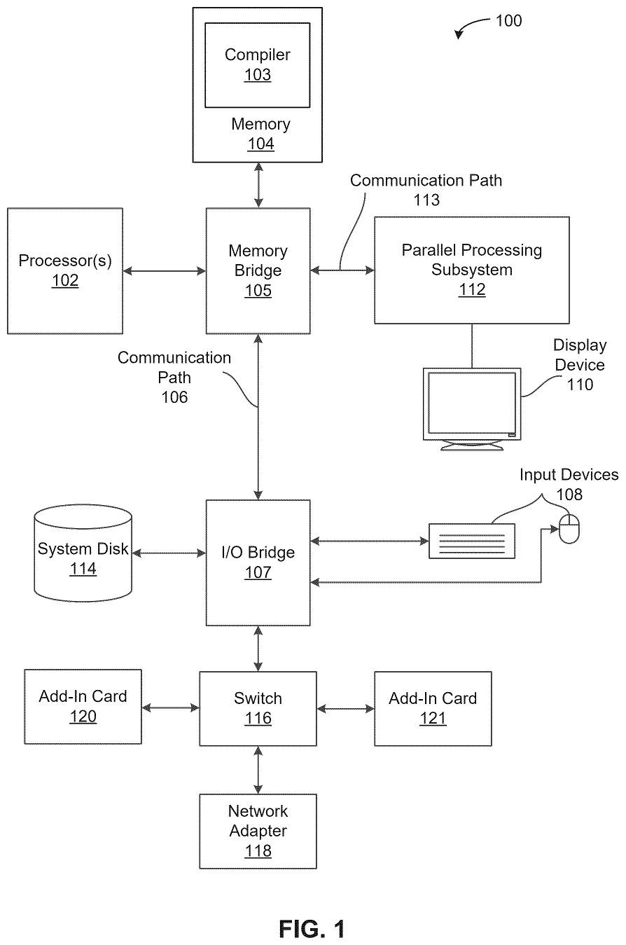

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 130. In one embodiment, switch 116 is configured to provide connections between I/O bridge 107 and other components of computer system 100, such as a network adapter 130 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

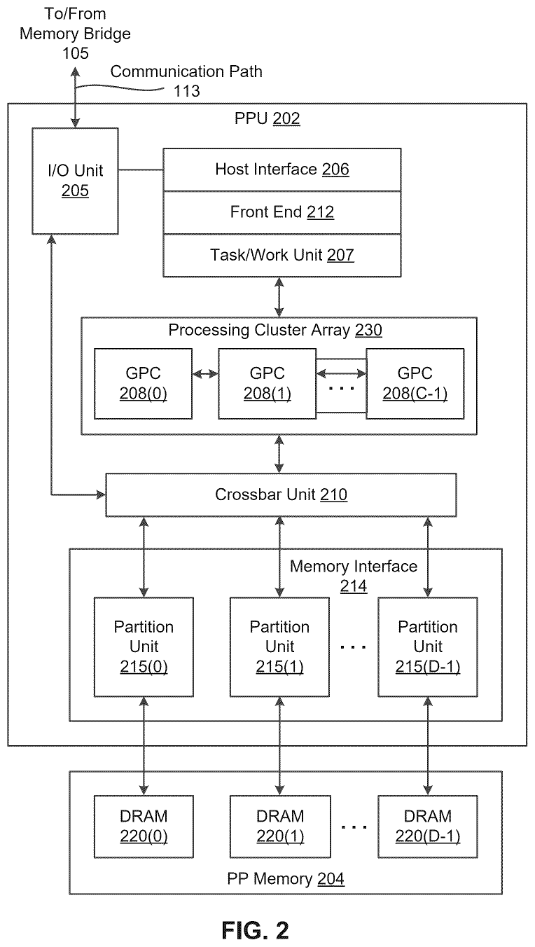

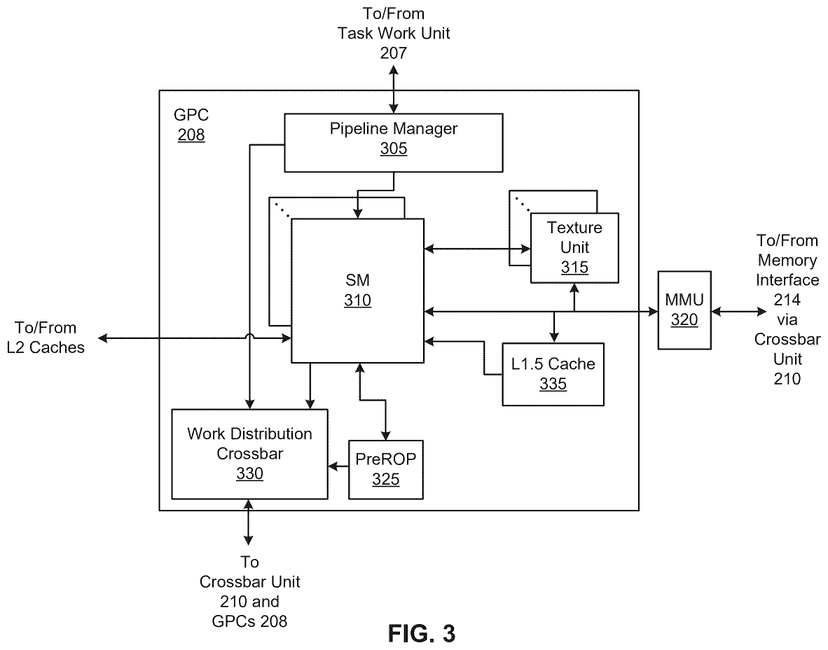

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

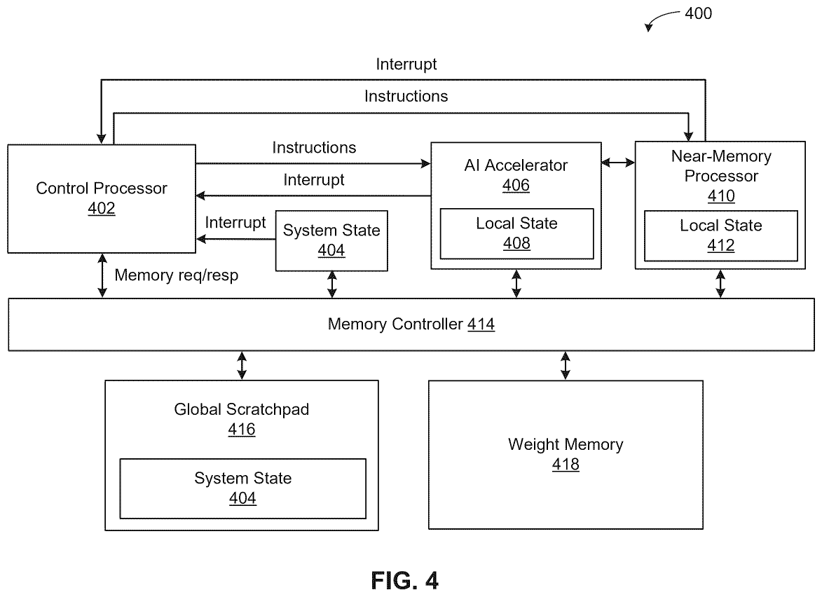

Illustratively, system memory 104 stores a compiler 103. Compiler 103 is configured to translate source code in a human-readable programming language into machine code that can be executed by a computer. In some embodiments, compiler 103 can translate source code into computations performed by an artificial intelligence accelerator 406 and/or a near-memory processor 410, described in greater detail below in conjunction with FIGS. 4-11. Although described herein primarily with respect to compiler 103 as a reference example, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 130 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 130.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 50R), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### System-on-Chip for Accelerating AI Workloads

FIG. 4 illustrates a system-on-chip (SoC) 400 that can be included in the parallel processing subsystem of FIG. 1, according to various embodiments. As shown, the SoC 400 includes, without limitation, a control processor 402, an artificial intelligence (AI) accelerator 406, a near-memory processor (NPM) 410, a memory controller 414, a global scratchpad 416, and a weight memory 418.

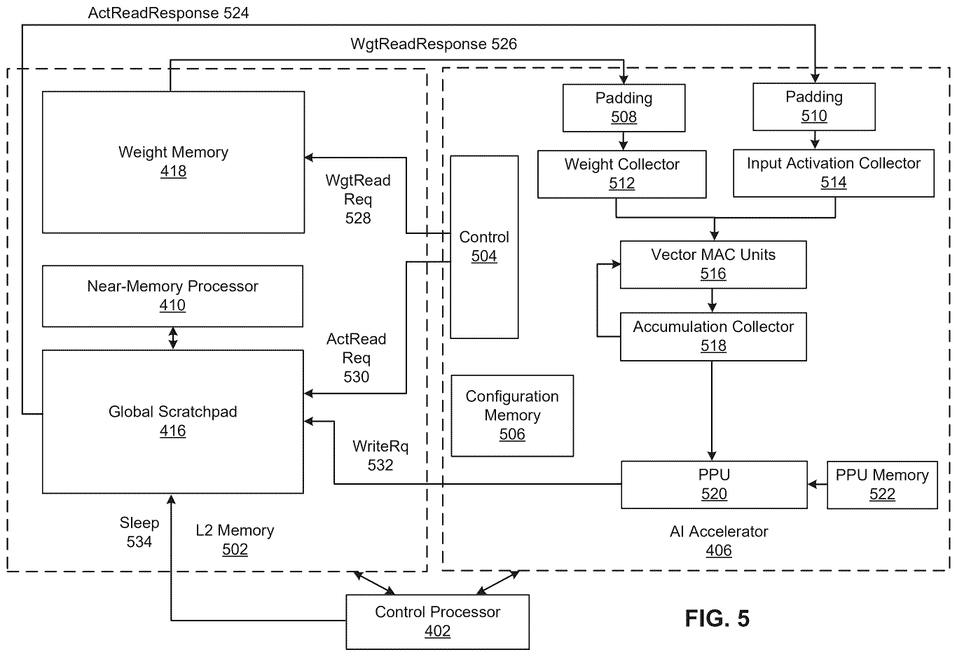

The AI accelerator 406 is a specialized hardware accelerator that includes circuitry for accelerating AI and machine learning applications, such as deep learning and neural network processing. Components of the AI accelerator 406 are described in greater detail below in conjunction with FIG. 5. Illustratively, the AI accelerator 406 maintains a local state 408 of the AI accelerator 406.

The NMP 410 is a processor that improves the performance of certain operations by moving the computing capability closer to the global scratchpad 416. For example, certain operations during the processing of neural networks (e.g., pooling operations) do not have much re-use and can be performed by reading data from the global scratchpad 416, performing the requisite computations, and then writing the results back to the global scratchpad 416, without moving the data a further distance to the AI accelerator 406. The NMP 410 can be implemented in any technically feasible manner in some embodiments, such as using one or more near-memory co-processors that are specialized processing units placed close to the global scratchpad 416 to provide computing resources at the periphery of the global scratchpad 416, using in-memory processing in which the memory array of the global scratchpad 416 itself is used for computation, using a compute-in-memory approach such as techniques to perform computations within the memory array of the global scratchpad 416 or using customized logic units integrated with the global scratchpad 416, and/or the like. By minimizing the distance the data is moved, the NMP 410 can reduce latency and power consumption. Illustratively, the NMP 410 maintains a local state 412 of the NMP 410. In some embodiments, certain memory operations can be efficiently handled by address generators rather than the NMP 410 or the AI accelerator 406.

The control processor 402 manages the flow of data and operations across components of the SoC 400. In some embodiments, the control processor 402 issues instructions that are executed by the AI accelerator 406 and/or the NMP 410. For example, the instructions could be for the AI accelerator 406 and/or the NMP 410 to execute one or more layers of a neural network. In such cases, when the execution is completed, the AI accelerator 406 and/or the NMP 410 can transmit interrupts to the control processor 402, notifying the control processor 402 that the execution is completed.

The global scratchpad 416 and the weight memory 418 are level 2 (L2) memories used to store frequently accessed data and instructions to speed up processing by reducing the need to access main memory as often. The weight memory 418 is a storage for parameters of a neural network. For example, in some embodiments, the weight memory 418 can be used to store the weights associated with one or more layers of a neural network. The global scratchpad 416 is a temporary storage for data during calculations, such as calculations involving a neural network. For example, in some embodiments, the global scratchpad 416 can store (1) input activations that are input into one or more layers of a neural network, and (2) output activations that are output by one or more layers of a neural network, for one or more layers of the neural network during training and/or inference operations. Illustratively, the global scratchpad 416 also stores a system state 404 of the SoC 400.

The memory controller 414 manages data flow between the processors, including the control processor 402, the AI accelerator 406, and the NMP 410 and the memory, including the global scratchpad 416 and the weight memory 418.

FIG. 5 illustrates how a neural network can be executed on the SoC 400 of FIG. 4, according to various embodiments. As shown, the AI accelerator 406 includes, without limitation, control logic 504, a configuration memory 506, padding units 508 and 510, a weight collector 512, an input activation collector 514, vector multiply-accumulate (MAC) units 516, an accumulation collector 518, a post-processing unit (PPU) 520, and a PPU memory 522.

As described, the control processor 402 manages the flow of data and operations across components of the SoC 400 by issuing instructions that are executed by the AI accelerator 406 and/or the NMP 410. For example, the control processor 402 could issue instructions for the AI accelerator 406 to execute one or more layers of a neural network, such as a batch of back-to-back layers of the neural network, and then return control to the control processor 402. In such a case, the instructions can be stored in the configuration memory 506. In addition, the control processor 402 can control the sleep 534 states of memory banks within the global scratchpad 416 and the weight memory 418, which are the level 2 (L2) memory 502. In some embodiments, the control processor 402 activates only the memory bank(s) storing data that is required to execute the one or more layers of the neural network, thereby switching such memory bank(s) to an “active state,” while maintaining the remaining memory bank(s) in other states that consume less leakage power. For example, memory banks storing data that needs to be used in the future could be switched to a “retention” state that consumes less leakage power than the “active” state, while memory banks that do not store any data related to the neural network can be switched to an “idle” state that consumes less leakage power than the “active” state and the “retention” state. In some embodiments, the control processor 402 can issue commands to the global scratchpad 416 and the weight memory 418 to switch the states of memory banks therein.

The control logic 504 includes circuitry that reads instructions from the configuration memory 506 and causes the instructions to be executed by the AI accelerator 406 and/or the NMP 410. Illustratively, after reading instructions from the configuration memory 506 to execute one or more layers of a neural network, the control logic 504 transmits (1) requests to read input activations, shown as activation read request 530, to the global scratchpad 416, and (2) requests to read weights for the layer(s) of the neural network, shown as weight read request 528, to the weight memory 418. In response to such requests, the global scratchpad 416 returns the requested data in read responses, shown as activation read response 524, to the AI accelerator 406, and the weight memory 418 returns weight read responses, shown as weight read response 526, to the AI accelerator 406.

Padding units 508 and 510 include circuitry configured to add padding to the activations in the activation read response 524 and the weights in the weight read response 526, respectively. In some embodiments, the padding includes zeros that are added when the vector MAC units 516 require inputs of a particular length, but the activations and/or weights have a different length. For example, when the vector MAC units 516 require vectors of length 32 as input, but the activations have a length of 8, then the padding unit 510 could pad each activation with 24 zeroes. As another example, when the vector MAC units 516 require images of a particular size as input, but the activations include smaller images, then the padding unit 510 could pad borders of the smaller images with zeroes. Another example is a convolution operation with 3×3 kernels, where the computation requires adding zeros along the border, which is independent of the size/length of the vector MAC units 516. Padding eliminates the need to store the zeroes explicitly in memory, which can save memory space.

The weight collector 512 is a memory that stores weights after any necessary padding has been added to weights in the weight read response 526 by the padding unit 508. The input activation collector 514 is a memory that stores input activations after any necessary padding has been added to activations in the activation read response 524.

The vector MAC units 516 are specialized hardware that include circuitry for performing multiply-accumulate operations on multiple data elements simultaneously, allowing for faster processing of large datasets according to the Single Instruction, Multiple Data (SIMD) paradigm. In particular, the vector MAC units 516 can perform multiply-accumulate operations using the weights and input activations with (optional) padding that is stored in the weight collector 512 and the input activation collector 514, respectively. For example, the multiply-accumulate operations could involve multiplying weights by input activations, dynamically generating weights and activations, and/or the like.

The accumulation collector 518 gathers intermediate calculation results from the vector MAC units 516 and accumulates the intermediate results together. In some embodiments, accumulating the intermediate results can include summing the intermediate results.

The PPU 520 performs post processing of the accumulated output. Any technically feasible post processing operations can be performed in some embodiments. In some embodiments, the post processing can include data format conversion operations and/or non-linear operations. For example, accumulated output that is 32 bits could be converted to 4 or 8 bits to save memory space. As another example, non-linear operations, such as tanh or sigmoid operations, could be performed on the accumulated output. The PPU memory 522 is a memory coupled to the PPU 520.

In operation, to execute a layer of a neural network, (1) weights of the layer and input activations are streamed from the weight memory 418 and the global scratchpad 416, respectively, into the AI accelerator 406; (2) the padding units 510 and 508 add any necessary padding to the input activations and the weights, respectively, after which the results are stored in the input activation collector 514 and the weight collector 512, respectively; (3) the vector MAC units 516 performs multiply-accumulate operations using the stored input activations and weights with (optional) padding that are stored in the input activation collector 514 and the weight collector 512, respectively, to generate intermediate results; (4) the accumulation collector 518 gathers the intermediate calculation results from the vector MAC units 516 and accumulates the intermediate results together; (5) the PPU 520 performs post processing on the accumulated output of the accumulation collector 518; and (5) output of the PPU 520 can be written via a write request 532 to the global scratchpad 416 as output activations, as described above. The foregoing steps can be repeated to execute multiple layers of a neural network.

When one or more layers are to be executed by the NMP 410, the control processor 402 can similarly configure the NMP 410 to execute the layers sequentially. As described, the NMP 410 is a processor that improves performance of certain operations by moving the computing capability closer to the global scratchpad 416. For example, certain operations do not have much re-use and can be performed by reading data from the global scratchpad 416, performing the requisite computations, and then writing the results back to the global scratchpad 416, without moving the data a further distance to the AI accelerator 406.

### Near-Memory Processor for Tensor-Level Operations

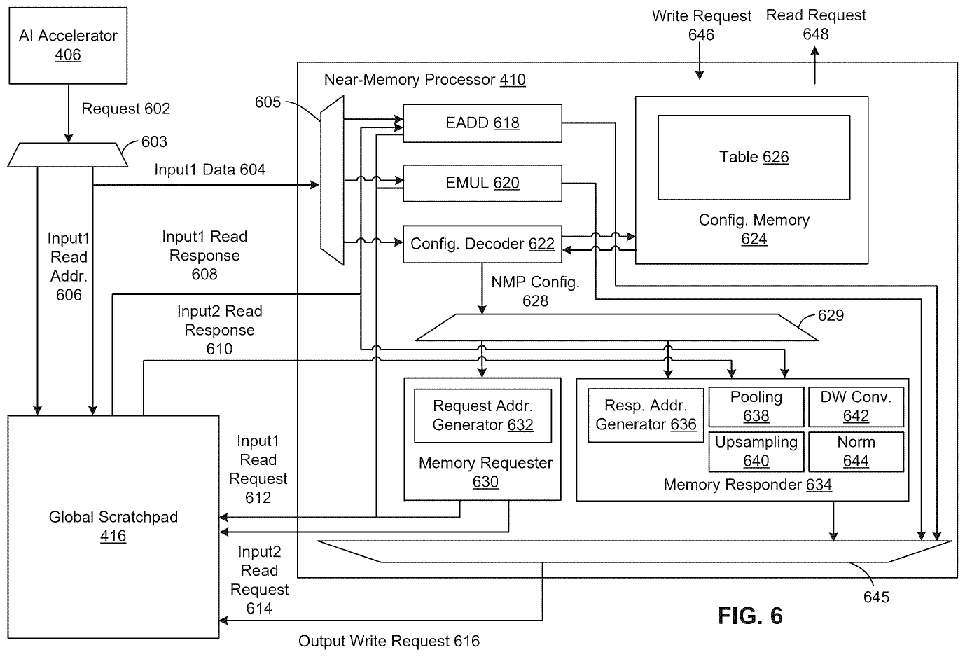

FIG. 6 is a more detailed illustration of the NMP 410 of FIG. 4, according to various embodiments. As shown, the NMP 410 includes, without limitation, an element-wise addition (EADD) unit 618; an element-wise multiply (EMUL) unit 620; a configuration decoder 622; a configuration memory 624; a memory request handler 630 (also referred to herein as “memory requester 630”); a memory response handler 634 (also referred to herein as “memory responder 634”); and multiplexers 605, 629, and 645, each of which can be implemented using any technically feasible circuitry. The configuration memory 624 stores a table 626. The memory requester 630 includes, without limitation, a request address generator 632. The memory responder 634 includes, without limitation, a response address generator 636, a pooling unit 638, an upsampling unit 640, a depthwise (DW) convolution unit 642, and a norm unit 644.

The EADD unit 618 performs element-wise addition on two input vectors (or arrays) of values. Corresponding elements in the input vectors are added together by the EADD unit 618 to produce an output vector.

The EMUL unit 620 performs element-wise multiplication on two input vectors (or arrays) of values. Corresponding elements in the input vectors are multiplied together by the EMUL unit 620 to produce an output vector. Although described herein primarily with respect to EADD and EMUL as reference examples of atomic operations, in some embodiments, the NMP 410 can include logic, implemented using circuitry, to perform any technically feasible atomic operations.

The configuration decoder 622 performs decoding of input data, shown as input1 data 604, that are not used for an EADD or an EMUL. In some embodiments, the input data includes data bits from a request, such as an output write request, that the AI accelerator 406 issues to the global scratchpad 416. In some embodiments, decoding the input data includes determining the types of operations to perform and a sequence of addresses in the global scratchpad 416 that need to be accessed. In some embodiments, the configuration decoder 622 determines the types of operations to perform and the sequence of addresses using a table 626 stored in the configuration memory 624. In some embodiments, the table 626 can store per-neural network layer instructions, such as an operation type, tensor dimensions, base addresses, scale factors, etc., and the configuration decoder 622 can decode the input data by identifying a corresponding index in the table 626 and using any suitable instructions associated with the index to perform the decoding.

The configuration memory 624 is a memory that can be used to store execution parameters, control settings, and memory access patterns, among other things, which the control processor 402 can write to the configuration memory 624 via write requests (shown as write request 646). The control processor 402 can also read from the configuration memory 624 via read requests (shown as read request 648). In some embodiments, the configuration memory 624 can be used to manage workload-specific configurations, synchronize operations, and enable efficient power and performance tuning. One of the workload-specific configurations is the types of operations to perform for a given input data. As described above, the table 626 in configuration memory 624 per-neural network layer instructions, such as an operation type, tensor dimensions, base addresses, scale factors, etc., which can be used to decode input data. Illustratively, when the input1 data 604 is not used for an EADD or an EMUL, the configuration decoder 622 can decode, using the table 626 stored in the configuration memory 624, the input1 data 604 to obtain an NMP configuration 628 that includes operations to perform and a sequence of addresses to access for the input1 data 604.

The memory requester 630 generates memory read requests to the global scratchpad 416. In particular, the memory requester 630 generates requests to read memory at the sequence of addresses indicated by the NMP configuration 628 that is output by the configuration decoder 622. As shown, the memory requester 630 includes the request address generator 632, which is a specialized hardware unit responsible for computing memory addresses for inclusion in read requests to the global scratchpad 416. In some embodiments, the request address generator 632 can compute memory addresses in a manner that optimizes access patterns, reduces memory latency, and/or improves overall computational efficiency.

In some embodiments, the memory requester 630 and the memory responder 634 are also padding-aware. Padding refers to extra values, such as zeroes or other neutral values that do not affect the results of a computation, that are added to data. In machine learning, padding is oftentimes added to the weight tensors that represent different layers of an artificial neural network, as well as to activation values that are input into the different layers. In some embodiments, the memory requester 630 checks whether generated memory addresses correspond to padding. For memory addresses corresponding to padding, the memory requester 630 does not transmit a read request to the global scratchpad 416, and the memory responder 634 directly synthesizes a 0 to use in computation(s) rather than using zero-padded data in a read response from the global scratchpad 416. In some embodiments, the memory requestor 630 can determine a generated address corresponds to padding when the generated address is outside the dimensions of a neural network layer to be executed or is outside the dimensions of an input image or other input activation. If the generated memory address is outside of such dimensions, the memory address is a padding address. For example, the dimensions of the neural network layer could be written to the configuration memory 624 by the control processor 402. As another example, in some embodiments, in addition to the dimensions of the neural network layer, the control processor 402 can also write, to the configuration memory 624, pad_c, pad_k, etc. values that indicate the number of values to be padded, which can vary depending on other runtime parameters such as precision.

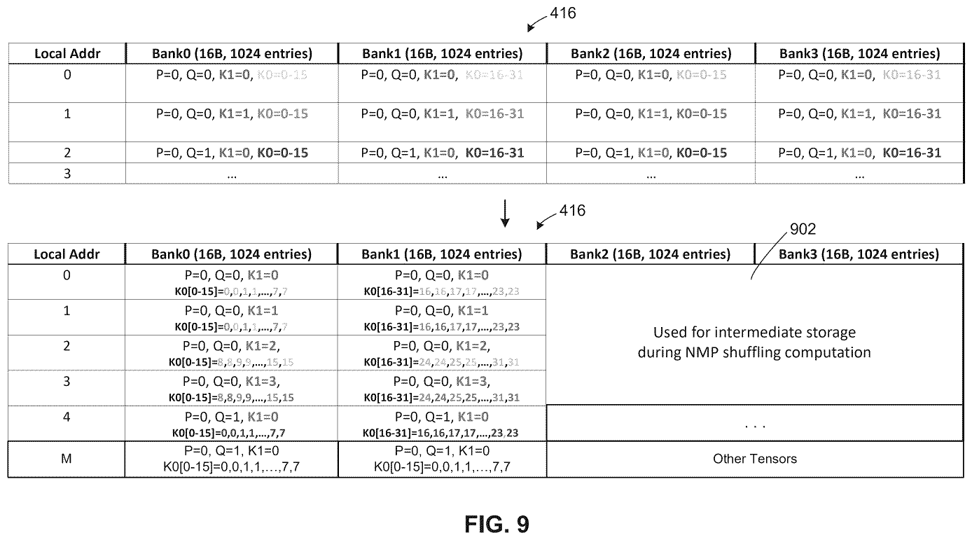

In some embodiments, the memory requester 630 utilizes variable bandwidth to access data from a single memory bank or multiple memory banks of the global scratchpad 416 that are clustered together in a memory bank cluster so as to improve performance. The memory banks are organized storage units within the global scratchpad 416 that facilitate efficient access to data. Each memory bank can include a set of memory cells or modules grouped together to function as a single entity. The grouped memory cells can be used for various tasks, such as storing data, accessing the stored data for computational operations, and storing the output of those computational operations. In some embodiments, the global scratchpad 416 is dynamically configurable to allocate memory according to memory bank cluster sizes specified in read and write requests to the global scratchpad 416. In such cases, the dynamic configuration can be specified in program code that is compiled by the compiler 103, described above in conjunction with FIG. 1, and executed by the NMP 410. Memory allocations are interleaved within each bank cluster and are sequential across bank clusters. A read or write request to the global scratchpad 416 can include a virtual memory address and a bank cluster size (as well as a block size to read or data to write, respectively). Logic within (or outside of) the global scratchpad 416 converts the virtual memory address to a physical memory address of the global scratchpad 416 to access, as described in the United States patent application titled, “TECHNIQUES FOR DYNAMICALLY CONFIGURING MEMORY IN A COMPUTING SYSTEM,” filed on Jan. 31, 2025, and having Ser. No. 19/043,355, which is hereby incorporated herein by reference in its entirety. Depending on the operation to perform, the memory requester 630 generates one or more read requests that each specify a bank cluster size, and data is read from one or multiple memory banks within bank cluster(s) at the same time via the read request(s). In some embodiments, the NMP 410 can be programmed with different multi-bank access configurations per clock cycle: per-memory bank or per-slice (i.e., group of memory banks), and the memory banks do not need to be adjacent to each other in the global scratchpad 416. For example, in the case of operations, such as a shuffle operation, that require two inputs and generate one output, the memory requester 630 could generate read request(s) that specify a memory bank cluster size required to retrieve data for the two inputs, and the data for the two inputs can be retrieved at the same time. As a specific example, a shuffle operation could be programmed to access four banks per cycle for load/store operations to shuffle two tensors, as discussed in greater detail below in conjunction with FIG. 9. In some embodiments, multi-bank access can be configured to dynamically adjust at a fine-grained operational granularity in the middle of neural network inference, such as at the kernel, channel, and/or tensor/layer level. For example, layer 1 (pooling) of a particular neural network could utilize 2 memory banks, layer 2 (shuffling) could utilize 4 memory banks, channel 1 of layer 3 (copy) could utilize 2 memory banks, channel 2 of layer 3 (copy) could utilize 1 memory bank, etc. Data that is retrieved from the global scratchpad 416 can be processed by the NMP 410 to generate an output that is written back to the global scratchpad 416. The ability of the NMP 410 to use variable bandwidth to access data stored in the global scratchpad 416 provides data-level parallelism, allowing for higher throughput and reduced latency for operations with very high memory-to-compute ratio.

The memory responder 634 includes various computational units for performing at least part of one or more tensor operations, shown as the pooling unit 638 for performing operations associated with pooling, the upsampling unit 640 for performing operations associated with upsampling, the DW convolution unit 642 for performing operations associated with DW convolutions, and the norm unit 644 for performing operations associated with normalization. In some embodiments, the memory responder 634 performs at least part of one or more tensor operations to generate an output, and the memory responder 634 further generates one or more memory write requests, such as the output write request 616, for writing the output to the global scratchpad 416.

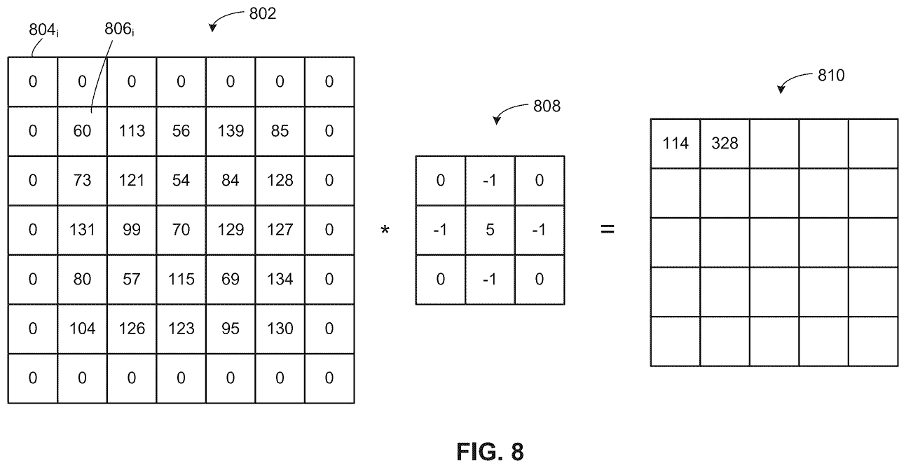

As a specific example of both adding padding and using variable bandwidth to access data, consider a DW convolution operation involving the memory requester 630 and the memory responder 634. The DW convolution operation is further described below in conjunction with FIG. 8. DW convolution is a type of convolution in which each input channel is convolved with a different kernel, referred to as a depthwise kernel. For a DW convolution, the memory requester 630 transmits, to the global scratchpad 416, read request(s) for two inputs, a set of weights of the depthwise kernel and activations. In some embodiments, the read request(s) can include multiple read requests along the dimensions of both the weights and activations for the DW convolution operation. In such cases, the number of read requests linearly correlates with the size of the DW activation and weight tensors. The read requests can also specify a bank cluster size. In addition, the memory requester 630 includes padding logic to ensure that read requests are not transmitted for generated memory addresses that correspond to padding. The memory responder 634 includes logic that directly inserts zeroes into padding regions and otherwise uses data returned in read responses from the global scratchpad 416. In some embodiments, the memory requester 630 and the memory responder 634 can perform operations for a DW convolution according to Algorithm 1 and Algorithm 2, respectively.

```
Algorithm 1
MemREQ SC_THREAD( ):
  for (p=0; p<p_pooled; p+=stride_p)
    for (q=0; q<q_pooled; q+=stride_q)
      for (k=0; k<k_groups; k+=1)
        for (r=0; r<kernel_r; r+=1)
          for (s=0; s<kernel_s; s+=1)
            if (padding == 0) {
              input1_rd_req.Push(addrgen1.GetAddr( ));
            }
            input2_rd_req.Push(addrgen2.GetAddr( ));
```

```
Algorithm 2
MemRSP SC_THREAD( ):
  for (p=0; p<p_pooled; p+=stride_p)
    for (q=0; q<q_pooled; q+=stride_q)
      for (k=0; k<k_groups; k+=1)
        sum = 0;
        for (r=0; r<kernel_r; r+=1)
          for (s=0; s<kernel_s; s+=1)
            if (padding == 0) {
              input1_rd_vec = input1_rd_rsp.Pop( );
            } else {
              input1_rd_vec = {0};
            }
            input2_rd_vec = input2_rd_rsp.Pop( );
            sum += input1_rd_vec * input2_rd_vec;
      output_wr_req.Push(sum);
      PostProcessing(sum, pp_sum);
      final_output.Push(pp_sum);
```

In operation, the multiplexer 603 routes data included in certain requests from the AI accelerator 406 to the NMP 410. For example, in some embodiments, data included in certain output write requests from the AI accelerator 406 can be routed to the NMP 410. As a specific example, in some embodiments, special op codes can specify that the AI accelerator 406 writing to certain memory addresses in the global scratchpad 416 will initiate a near memory computation by the NMP 410. Illustratively, input1 data 604 included in a request 602 has been routed to the NMP 410. The multiplexer 605 further routes input1 data 604 to the EADD unit 618, the EMUL unit 620, or the configuration decoder 622, depending on whether operation(s) associated with input1 data 604 are EADD, EMUL, or other more complex operations, respectively. Illustratively, if input1 data 604 is routed to the EADD unit 618 or the EMUL unit 620, then the EADD unit 618 or the EMUL unit 620 can issue an input1 read request 612 to the global scratchpad 416 for additional data that is required to perform an EADD or EMUL operation, respectively. In some embodiments, the input1 read request 612 can use the same memory address as an output write request that is issued by AI accelerator 406 and from which the input1 data 604 is obtained, shown as input1 read address 606. The global scratchpad 416 returns the requested data in an input1 read response 608 to the EADD unit 618 or the EMUL unit 620. Then, the EADD unit 618 or the EMUL unit 620 performs an EADD or EMUL operation, respectively, using (1) the input1 data 604 from the request 602 as a first operand and (2) the data in the input1 read response 608 as a second operand to generate an output, and the EADD unit 618 or the EMUL unit 620 generates a write request (e.g., output write request 616) to write the output back to the same memory address in the global scratchpad 416. Accordingly, output requests from the AI accelerator 406 can trigger, for an EADD or an EMUL, read, modify, and write operations to a particular memory location in the global scratchpad 416.

In addition to read, modify, and write operations for EADD and EMUL operations, the NMP 410 also permits read, modify, and write operations for more complex tensor-level operations, thereby improving performance by moving the computing of such tensor-level operations closer to the global scratchpad 416. Illustratively, if input1 data 604 included in the request 602 is not for an EADD or an EMUL, then the multiplexer 605 routes input1 data 604 to the configuration decoder 622. As described, the configuration decoder 622 performs decoding of input data by determining the types of operations to perform and a sequence of addresses in the global scratchpad 416 that need to be accessed, shown as the NMP configuration 628 that is output by the configuration decoder 622. In some embodiments, the configuration decoder 622 determines the types of operations to perform and the sequence of addresses using the table 626 in the configuration memory 624 that stores per-neural network layer instructions, such as an operation type, tensor dimensions, base addresses, scale factors, etc., which can be used to decode input data. Based on the NMP configuration 628, the memory requester 630 generates one or more read requests, shown as input1 read request 612 and input2 read request 614, to read from the sequence of addresses in the global scratchpad 416 that are indicated by the NMP configuration 628. The global scratchpad 416 returns the requested data in read responses, shown as input1 read response 608 and input2 read response 610, to the memory responder 634. Depending on the types of operation(s) being performed, the returned data can be processed by one or more of the computational units in the memory responder 634, such as the pooling unit 638, the upsampling unit 640, the DW convolution unit 642, and/or the norm unit 644. An output of the computational unit(s) can be included in one or more write requests, such as output write request 616, to the global scratchpad 416. The write request(s) can write to memory address(es) generated by the response address generator 636. After the write request(s) are issued, the NMP 410 can also transmit a response to the AI accelerator 406 indicating that operations by the NMP 410 are complete, and the AI accelerator 406 can begin executing subsequent operations. Further, in some embodiments, a single write request from the AI accelerator 406 can be used to trigger the execution of multiple back-to-back per-neural network layer instructions stored sequentially from a base address location in the configuration memory 624. Accordingly, tensor-level operations can be relatively seamlessly integrated as read, modify, write operations by the NMP 410, with lower data movement cost than if all operations were performed by the AI accelerator 406.

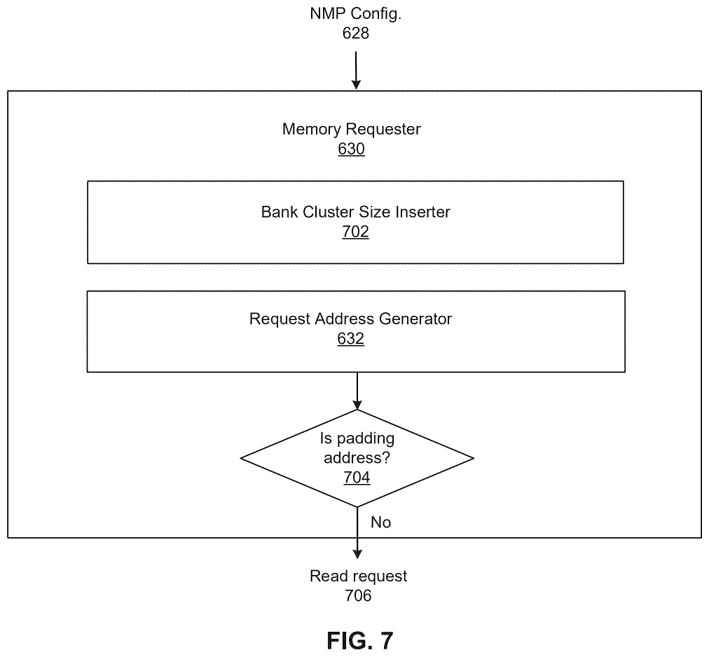

FIG. 7 is a more detailed illustration of the memory requester 630 of FIG. 6, according to various embodiments. As shown, the memory requester 630 includes, without limitation, the request address generator 632 and a bank cluster size inserter 702. As described, the request address generator 632 is a specialized hardware unit responsible for computing memory addresses for inclusion in read requests to the global scratchpad 416, and the memory requester 630 can compute memory addresses in a manner that optimizes access patterns, reduces memory latency, and/or improves overall computational efficiency. In addition, the memory requester 630 is padding-aware in some embodiments. In such cases, the memory requester 630 checks 704 if each memory address generated by the request address generator 632 corresponds to padding. Only if the generated memory address does not correspond to padding does the memory requester 630 transmit a read request 706 to the global scratchpad 416 to read from the generated memory address. For example, in some embodiments, the memory requester 630 can determine that a generated memory address corresponds to padding when the generated memory address is outside of the dimensions of a neural network layer to be executed or the generated memory address is outside the dimensions of an input image or other input activation. For memory addresses corresponding to padding, the memory responder 634 directly synthesizes a 0, rather than using data in a read response from the global scratchpad 416.

As described, in some embodiments, the memory requester 630 can also utilize variable bandwidth to access data from a single memory bank or multiple memory banks of the global scratchpad 416 that are clustered together in a memory bank cluster. The bank cluster size inserter 702 is responsible for inserting bank cluster sizes into read requests that each include a virtual memory address and a bank cluster size (and the block size to read). Logic within (or outside of) the global scratchpad 416 can then convert the virtual memory address to a physical memory address of the global scratchpad 416 that is accessed. In some embodiments, the memory responder 634 can similarly include a bank cluster size inserter that inserts bank cluster sizes into write requests to the global scratchpad 416.

FIG. 8 illustrates how the NMP 410 of FIG. 4 can perform a depthwise convolution with padded data, according to various embodiments. As described, DW convolution is a type of convolution in which each input channel is convolved with a different kernel, referred to as a depthwise kernel. As shown, the NMP 410 can perform a DW convolution that includes convolving an input channel 802 with a kernel 808 to generate a DW convolution output 810. Although only two numerical values of the DW convolution output 810 are shown for conciseness, it should be understood that the DW convolution output 810 includes additional numerical values. In addition, NMP 410 can add padding, shown as zeroes 8041 (referred to herein collectively as zeroes 804 and individually as a zero 804), to borders of the image for the input channel 802 when the DW convolution unit 642 requires images of a particular size as input, but the image for the input channel 802 is a smaller size. More generally, padding can be added to weight tensors that represent different layers of an artificial neural network and/or activation values that are input into the different layers.

In some embodiments, for generated memory addresses that correspond to padding, the memory requester 630 does not transmit a read request to the global scratchpad 416, and the memory responder 634 directly synthesizes a 0 to use in computation(s) by computational unit(s) in the memory responder 634, such as the DW convolution unit 642, rather than using data in a read response from the global scratchpad 416. In such cases, the global scratchpad 416 can store inputs and outputs in a compact form without padding zeroes, and the NMP 410 that is padding-aware will skip read requests to the global scratchpad 416 whenever a padding zero is required for downstream operations (e.g., DW convolution). Instead, the NMP 410 automatically synthesizes the required padding zeroes, without requesting memory access. Because padding zeroes are automatically synthesized, rather than being stored explicitly in the global scratchpad 416, storage resources, power, and latency can be saved. Outputs of the NMP 410, such as the DW convolution output 810, can also be stored compactly in the global scratchpad 416, without the padding zeroes of the next operation.

FIG. 9 illustrates how the NMP 410 of FIG. 4 can perform a shuffle operation using variable bandwidth requests, according to various embodiments. As shown, when the global scratchpad 416 includes four memory banks Bank0, Bank1, Bank2, and Bank3, and each memory bank includes entries that are 16B wide, the memory allocation for a shuffle operation performed by the NMP 410 can be as follows. Initially a first input tensor (not shown) having dimensions P, Q, and K can be stored across memory banks Bank0 and Bank1, and a second input tensor (not shown) having dimensions P, Q, and K, can be stored across memory banks Bank2 and Bank3. In such a case, the bank cluster size can be set to 2 for both the first input tensor and the second input tensor. The shuffle operation can involve the NMP 410 (1) reading the first and second input tensors that are stored in the global scratchpad 416 via read requests that specify a memory bank size of 2, and (2) generating a shuffled output tensor by writing the first and second input tensors in an interleaved manner stored across memory banks Bank0 and Bank1, with a bank cluster size equal to 2. For example, in some embodiments, the interleaving can be performed across the channel dimension, which is shown as the K0[0-15], K0[16-31], etc. of the shuffled output tensor including interleaved values (e.g., the interleaved values 0, 0, 1, 1, . . . , 7, 7 for K0[0-15] in Bank0 and at local address 0) from the first and second input tensors. In addition, the shuffle operation can utilize an intermediate storage during the shuffling computation, shown as intermediate storage 902 provided by memory banks Bank2 and Bank3 of the global scratchpad 416.

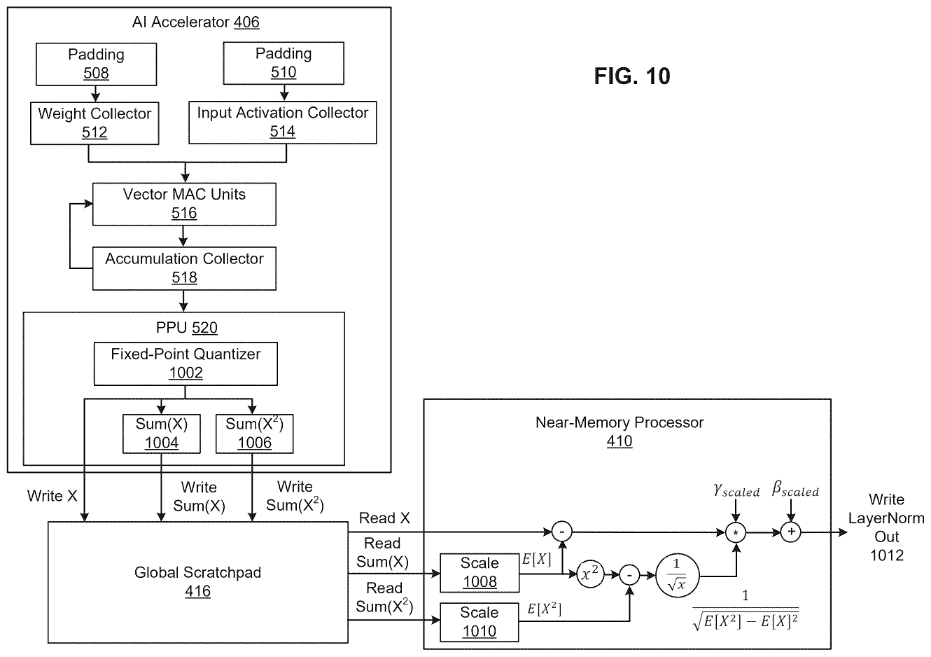

FIG. 10 illustrates how the AI accelerator 406 and the NMP 410 of FIG. 4 can perform a LayerNorm operation, according to various embodiments. As shown, the AI accelerator 406 includes, without limitation, the padding units 508 and 510, the weight collector 512, the input activation collector 514, the vector MAC units 516, the accumulation collector 518, and the PPU 520, which are described above in conjunction with FIG. 5. The PPU 520 includes, without limitation, a fixed-point quantizer 1002. The fixed-point quantizer 1002 takes continuous-valued inputs (e.g., represented using floating-point numbers) and maps such inputs to discrete values with a fixed number of bits.

LayerNorm is a technique in machine learning that normalizes the distribution of inputs in a layer of an artificial neural network. In some embodiments, LayerNorm can be applied to normalize along the channel (C) and spatial (H,W) dimensions of an image batch. Such a LayerNorm can be expressed as:

$${x}^{′} = \frac{x - E [ x ]}{\sqrt{E [ {x}^{2} ] - {E [ x ]}^{2}}} * γ + β , \qquad ( 1 )$$

Where x is an input sample and γ and β are learnable affine transform parameters. To perform a LayerNorm operation, the AI accelerator 406 computes intermediate results x, Sum(x), and Sum(x²), which includes quantizing outputs of the vector MAC units 516 to obtain x as well as summing x 1004 and summing x² 1006 via the fixed-point quantizer 1002. The AI accelerator 406 writes the intermediate results x, Sum(x), and Sum(x²) to the global scratchpad 416. Once all these values are stored, the AI accelerator 406 sends another write request that triggers the start of normalization steps in the NMP 410. In some embodiments, the AI accelerator 406 and the NMP 410 can perform computations according to the pseudocode of Algorithm 3. In Algorithm 3, the second for loop can be performed by the AI accelerator 406 in conjunction with the NMP 410, and the third for loop can be performed by the NMP 410 alone. The NMP 410 reads the intermediate results x, Sum(x), and Sum(x²) that are written by the AI accelerator 406 to the global scratchpad 416. The NMP 410 performs post-processing computations using the intermediate results x, Sum(x), and Sum(x²) to generate a final LayerNorm result that the NMP 410 writes to the global scratchpad 416, shown as writing LayerNorm out 1012. Illustratively, the NMP 410 scales 1008 and 1010 the intermediate results Sum(x) and Sum(x²) to obtain the expectations E[x] and E[x²], respectively. The NMP 410 uses the intermediate result x that is read from the global scratchpad 416 and the expectations E[x] and E[x²] to compute the LayerNorm according to equation (1). Because the NMP 410 processes the intermediate results to compute the final LayerNorm output, the computations are synergistically divided between the AI accelerator 406 and the NMP 410, as opposed to requiring two passes through the tensor by the AI accelerator 406, which would involve the AI accelerator 406 reading data from and writing data to the global scratchpad 416 an additional time. Accordingly, data movement is reduced, and the performance of LayerNorm operations can be improved.

Algorithm 3:

```
Input: group of vectors [x₀, x₁, ... , x_{K-1}] along the channel (C), and spatial (H,W)
dimensions for a single image batch (vectors coming straight from PEs)
Output: normalized group of vectors [x′₀, x′₁, ... , x′_{K-1}]
Group size G
Image dim K = C*H*W
Tiled image dim D = K/T where T is tile size
For group g = 0 to G − 1 do
  scalar expt = E[x] = 0;
  scalar expt_{sq} = E[x²] = 0;
  For dim i = 0 to D − 1 do
  $exp t += \frac{Σ {x}_{i}}{D} ; // using VSUM ( )$
  $exp {t}_{s q} + = \frac{Σ {x}_{i}^{2}}{D} ; // using EMUL ( ) and VSUM ( )$
$scalar inv\_std = \frac{1}{\sqrt{exp {t}_{s q} - exp {t}^{2}}} ; // using ac\_math ∷ ac\_inverse \_sqrt \_pwl ( )$
For dim i = 0 to D − 1 do
  ${x}_{i}^{′} = ( {x}_{i} - exp t ) // using EADD ( ) after negation of exp t$
  ${x}_{i}^{′} = {x}_{i}^{′} * inv\_std // using EMUL ( )$
  ${x}_{i}^{′} = {x}_{i}^{′} * {γ}_{i} // using EMUL ( )$
  ${x}_{i}^{′} = {x}_{i}^{′} + {β}_{i} // using EADD ( )$
```

In some embodiments, the xᵢ and

$${x}_{i}^{′}$$

in Algorithm 3 can be in INT8 precision; the γᵢ and βᵢ can be in INT16 precision; and the expt, expt_{sq}, inv_{std} can be in INT32 precision.

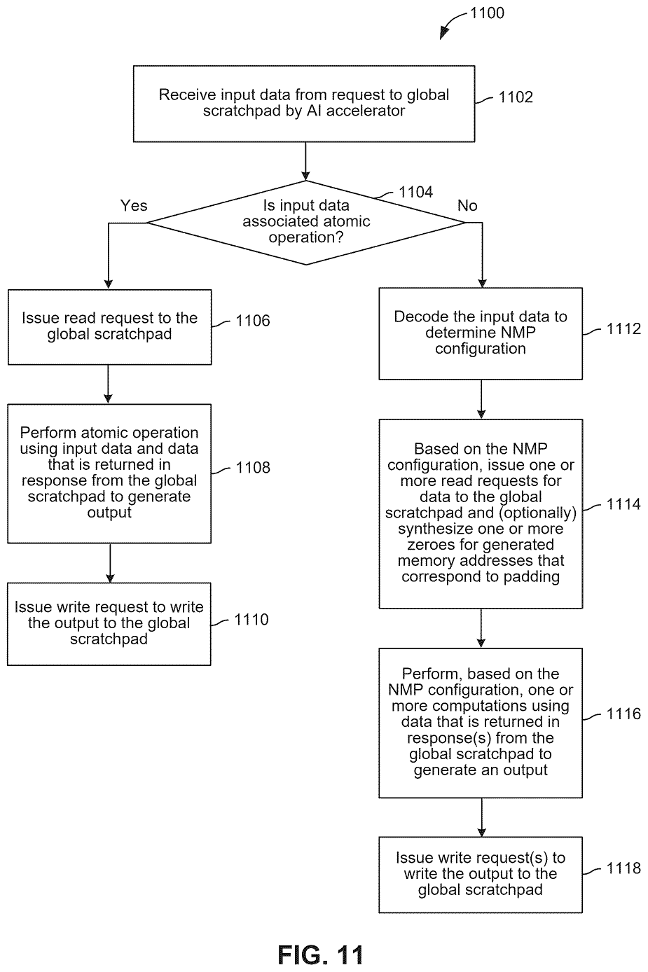

FIG. 11 is a flow diagram of method steps for performing computations using a near-memory processor, according to various embodiments. Although the method steps are described in conjunction with the systems of FIGS. 1-7, persons skilled in the art will understand that any system configured to perform the method steps, in any order, falls within the scope of the present disclosure.

As shown, a method 1100 begins at step 1102, where the NMP 410 receives input data from a request to the global scratchpad 416 by the AI accelerator 406. In some embodiments, the request can be an output write request from the AI accelerator 406 that triggers additional processing by the NMP 410. In some embodiments, special op codes can specify that the AI accelerator 406 writing to certain memory addresses in the global scratchpad 416 will initiate a near memory computation by the NMP 410. In the case of a LayerNorm operation, the request from the AI accelerator 406 can be a write request from the AI accelerator 406 after requests to write the intermediate results x, Sum(x), or Sum(x²), described above in conjunction with FIG. 10. More specifically, for LayerNorm, multiple write requests can be used to store x, Sum(x), and Sum(x²), in the global scratchpad 416. Once all these values are stored, the AI accelerator 406 sends another write request that triggers the start of normalization steps in the NMP 410. Further, in some embodiments, a single write request from the AI accelerator 406 can be used to trigger the execution of multiple back-to-back per-neural network layer instructions stored sequentially from a base address location in the configuration memory 624.

At step 1104, the multiplexer 605 of the NMP 410 determines whether the input data is associated with an atomic operation, such as an EADD or an EMUL operation. If the input data is associated with an atomic operation, then the method 1100 continues to step 1106, where the EADD unit 618 or the EMUL unit 620 issues a read request to the global scratchpad 416 after the input data is routed to the EADD unit 618 or the EMUL unit 620 by the multiplexer 605. In some embodiments, the read request can use the same memory address as an output write request that was issued by the AI accelerator 406 and from which the input data received at step 1102 was obtained.

At step 1108, the EADD unit 618 or the EMUL unit 620 of the NMP 410 performs an atomic operation, namely an EADD or an EMUL operation, respectively, using the input data and data that is returned in a response from the global scratchpad 416 to generate an output. Then, at step 1110, the EADD unit 618 or the EMUL unit 620 issues a write request to write the output to the global scratchpad 416.

On the other hand, if the input data is not associated with an atomic operation, then the method 1100 proceeds directly to step 1112, where the configuration decoder 622 decodes the input data to determine an NMP configuration after the input data is routed to the configuration decoder 622 by the multiplexer 605. In some embodiments, the NMP configuration includes the types of operations to perform and a sequence of addresses in the global scratchpad 416 that need to be accessed. In some embodiments, the NMP configuration can be determined using the table 626 in the configuration memory 624 that stores per-neural network layer instructions, such as an operation type, tensor dimensions, base addresses, scale factors, etc. In such cases, the configuration decoder 622 can decode the input data by identifying a corresponding index in the table 626 and using any suitable instructions associated with the index to perform the decoding.

At step 1114, based on the NMP configuration, the memory requester 630 of the NMP 410 issues one or more read requests for data to the global scratchpad 416 and, optionally, the memory responder 634 of the NMP 410 synthesizes one or more zeroes for generated memory addresses that correspond to padding. Returning to the LayerNorm example, the memory requester 630 can issue read requests for the intermediate results x, Sum(x), or Sum(x²) output by the AI accelerator 406, as described above in conjunction with FIG. 10. The global scratchpad 416 returns the data that is requested by the memory requester 630 to the memory responder 634 of the NMP 410 in one or more read responses.

In some embodiments, the NMP 410 is padding-aware. In such cases, the NMP 410 synthesizes zeroes for any generated memory addresses that correspond to padding, rather than making read requests to the global scratchpad 416. Because padding zeroes are automatically synthesized, rather than being explicitly stored in and read from the global scratchpad 416, storage resources, power, and latency can be saved.

In some embodiments, depending on the operation(s) being performed, the NMP 410 utilizes variable bandwidth to access data from a single memory bank or multiple memory banks of the global scratchpad 416 that are clustered together in a memory bank cluster. In such cases, the global scratchpad 416 is dynamically configurable to allocate memory according to memory bank cluster sizes specified in read and write requests to the global scratchpad 416, with memory allocations being interleaved within each bank cluster and sequential across bank clusters. A read or write request to the global scratchpad 416 can include a bank cluster size and a virtual memory address (as well as the block size to read or data to write, respectively), and the global scratchpad 416 converts the virtual memory address to a physical memory address to access. Depending on the operation(s) being performed, the memory requester 630 generates one or more read requests that each specify a bank cluster size so that data is read from one or multiple memory banks at the same time. In some embodiments, the NMP 410 can be programmed with different multi-bank access configurations per clock cycle: per-memory bank or per-slice (i.e., group of memory banks), and the memory banks do not need to be adjacent to each other in the global scratchpad 416. In some embodiments, multi-bank access can be configured to dynamically adjust at a fine-grained operational granularity in the middle of neural network inference, such as at the kernel, channel, and/or tensor/layer level. The ability of the NMP 410 to use variable bandwidth to access data stored in the global scratchpad 416 provides data-level parallelism, allowing for higher throughput and reduced latency for operations with very high memory-to-compute ratio.

At step 1116, memory responder 634 of the NMP 410 performs, based on the NMP configuration, one or more computations using data that is returned in a response from the global scratchpad 416, which may also be padded with the (optional) zeroes if appropriate, to generate an output. For example, the computation(s) could include pooling, DW convolution, upsampling, or norm operations performed by the pooling unit 638, the DW convolution unit 642, the upsampling unit 640, or the norm unit 644, respectively. Returning to the LayerNorm example, the computations could include scaling the intermediate results Sum(x) and Sum(x²) to obtain the expectations E[x] and E[x²], respectively, and using the intermediate result x that is read from the global scratchpad 416 and the expectations E[x] and E[x²] to compute a LayerNorm according to equation (1), as described above in conjunction with FIG. 10.

At step 1118, the memory responder 634 of the NMP 410 issues one or more write requests to write the output to the global scratchpad 416. Returning to the LayerNorm example, the memory responder 634 can write the LayerNorm output to the global scratchpad 416. In some embodiments, depending on the operation(s) being performed, the write request(s) can write the output to a single memory bank or multiple memory banks of the global scratchpad 416 that are clustered together in a memory bank cluster. After the write requests are issued at step 1118 or 1110, the NMP 410 can also transmit a response to the AI accelerator 406 indicating that operations by the NMP 410 are complete, and the AI accelerator 406 can begin executing subsequent operations.

In sum, techniques are disclosed for performing tensor-level operations using a near-memory processor. In some embodiments, the NMP includes an EADD unit, an EMUL unit, a configuration decoder, a configuration memory, a memory requester, and a memory responder. In operation, the NMP receives input data from a request, such as an output write request, that is issued by an AI accelerator to a global scratchpad memory. The input data is routed to the EADD unit, the EMUL unit, or the configuration decoder, depending on whether the input data is associated with EADD, EMUL, or other more complex operations, respectively.

If the input data is routed to the EADD unit or the EMUL unit, then the EADD unit or the EMUL unit issues a read request to the global scratchpad for data that is required to perform an EADD or an EMUL operation, respectively. In some embodiments, the read request can use the same memory address as an output write request that was issued by the AI accelerator and from which the input data was obtained. Using the input data and data that is returned by the global scratchpad in a read response as two operands, the EADD unit or the EMUL unit performs the EADD or the EMUL operation, respectively, to generate an output, and the NMP transmits a write request to write the output back to the same memory address in the global scratchpad. Accordingly, output requests from the AI accelerator can trigger, for an EADD or an EMUL, read, modify, and write operations to a particular memory location in the global scratchpad.

In addition to read, modify, and write operations for EADD and EMUL operations, the NMP also permits read, modify, and write operations for more complex tensor-level operations. When the input data is associated with a more complex operation, then the input data is routed to the configuration decoder. The configuration decoder performs decoding of input data by using a table stored in the configuration memory to determine an NMP configuration that includes the types of operations to perform and a sequence of addresses in the global scratchpad that need to be accessed. Based on the NMP configuration, the memory requester generates one or more read requests to read from the sequence of addresses in the global scratchpad that are indicated by the NMP configuration. In some embodiments, the memory requester is padding-aware and does not issue requests to read data from memory addresses corresponding to padding. Instead, the memory responder synthesizes zeroes to use in computations for such memory addresses. In some embodiments, the memory requester utilizes variable bandwidth to access data from a single memory bank or multiple memory banks of the global scratchpad that are clustered together in a memory bank cluster. Data that is returned in one or more responses to read request(s) from the memory requester are processed by one or more of the computational units in the memory responder. For example, the intermediate results for a LayerNorm operation can be processed to compute a LayerNorm output. Then, the NMP issues one or more write requests to write the output of the computational unit(s) to the global scratchpad, including to a single memory bank or multiple memory banks of a memory bank cluster.

One technical advantage of the disclosed techniques relative to the prior art is that, with the disclosed techniques, computations including tensor operations are performed, at least in part, using a near-memory processor that performs processing closer to a memory than an AI accelerator performs processing. As a result, data movements between the AI accelerator and the memory can be reduced, improving the performance of a computing device that includes the AI accelerator and the near-memory processor and reducing energy consumption. The disclosed techniques also permit the near-memory processor to store and retrieve data across multiple memory banks within a memory bank cluster of the memory simultaneously, which can increase overall data transfer rates. In addition, the disclosed techniques permit the near-memory processor to automatically synthesize zeroes that are used for padding, without requiring the zeroes to be stored in memory, thereby saving storage space, power, and access latency. These technical advantages provide one or more technological improvements over prior art approaches.

1. In some embodiments, a computer-implemented method for processing data comprises receiving, by a first processor, first data from a first request transmitted by a second processor to a memory, performing, by the first processor, at least part of a tensor operation based on the first data and second data stored in the memory to generate a first output, and writing, by the first processor, the first output to the memory, wherein the first processor performs processing closer to the memory than the second processor performs processing.

2. The computer-implemented method of clause 1, wherein the memory comprises a plurality of memory banks, and performing at least part of the tensor operation comprises accessing data from one or more memory banks that are included in the plurality of memory banks and a single memory bank cluster based on a memory bank cluster size specified in a second request from the first processor to the memory.

3. The computer-implemented method of clauses 1 or 2, wherein performing, by the first processor, at least part of the tensor operation comprises, in response to determining that padding needs to be added for a generated memory address, generating, by the first processor, a zero, without reading data stored in the memory at the generated memory address.

4. The computer-implemented method of any of clauses 1-3, wherein performing, by the first processor, at least part of the tensor operation comprises, in response to determining that padding does not need to be added for a generated memory address, transmitting, by the first processor to the memory, a second request to read data stored in the memory at the generated memory address.

5. The computer-implemented method of any of clauses 1-4, wherein the tensor operation is one of a LayerNorm operation, a pooling operation, a depthwise convolution operation, a shuffle operation, or an upsampling operation.

6. The computer-implemented method of any of clauses 1-5, wherein performing, by the first processor, at least part of the tensor operation comprises determining, by the first processor and using a configuration memory, one or more operations to perform and one or more memory addresses in the memory to access.

7. The computer-implemented method of any of clauses 1-6, wherein the first request is a write request.

8. The computer-implemented method of any of clauses 1-7, further comprising receiving, by the first processor, third data from a second request transmitted by the second processor to the memory, and performing, by the first processor, an atomic operation based on the third data and fourth data stored in the memory to generate a second output.

9. The computer-implemented method of any of clauses 1-8, further comprising performing, by the first processor, at least part of another tensor operation based on the first data and third data stored in the memory to generate a second output, wherein one or more first instructions associated with the tensor operation and one or more second instructions associated with the another tensor operation are stored sequentially from a base address location in the memory, and writing, by the first processor, the second output to the memory.

10. The computer-implemented method of any of clauses 1-9, wherein the second processor comprises an artificial intelligence (AI) accelerator.

11. In some embodiments, an integrated circuit comprises a memory, a first processor configured to receive first data from a first request, perform at least part of a tensor operation based on the first data and second data stored in the memory to generate a first output, and write the first output to the memory, and a second processor configured to issue the first request to the memory, wherein the first processor performs processing closer to the memory than the second processor performs processing.

12. The integrated circuit of clause 11, wherein the memory comprises a plurality of memory banks, and performing at least part of the tensor operation comprises accessing data from one or more memory banks that are included in the plurality of memory banks and a single memory bank cluster based on a memory bank cluster size specified in a second request from the first processor to the memory.

13. The integrated circuit of clauses 11 or 12, wherein performing, by the first processor, at least part of the tensor operation comprises in response to determining that padding needs to be added for a generated memory address, generating, by the first processor, a zero, without reading data stored in the memory at the generated memory address, and in response to determining that padding does not need to be added for a generated memory address, transmitting, by the first processor to the memory, a second request to read data stored in the memory at the generated memory address.

14. The integrated circuit of any of clauses 11-13, wherein the first processor is configured to determine that padding needs to be added for the generated memory address based on the generated memory address being outside one or more dimensions of a layer of a neural network or one or more dimensions of an input activation into the layer of the neural network.

15. The integrated circuit of any of clauses 11-14, wherein the tensor operation is one of a norm operation, a pooling operation, a depthwise convolution operation, a shuffle operation, or an upsampling operation.

16. The integrated circuit of any of clauses 11-15, wherein the tensor operation is a LayerNorm operation and performing, by the first processor, at least part of the LayerNorm operation comprises computing one or more expectations based on the second data, and computing a LayerNorm based on the one or more expectations.

17. The integrated circuit of any of clauses 11-16, wherein performing, by the first processor, at least part of the tensor operation comprises determining, by the first processor and based on a table stored in a configuration memory, one or more operations to perform and one or more memory addresses in the memory to access.

18. The integrated circuit of any of clauses 11-17, wherein the first request is a request to write data that is output by the second processor to the memory.

19. The integrated circuit of any of clauses 11-18, wherein the integrated circuit comprises a graphics processing unit (GPU).

20. In some embodiments, a system comprises a memory, and a first processor configured to receive first data from a first request, perform at least part of a tensor operation based on the first data and second data stored in the memory to generate a first output, and write the first output to the memory, and a second processor configured to issue the first request to the memory, wherein the first processor performs processing closer to the memory than the second processor performs processing.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing data, the method comprising:
receiving, by a first processor, first data from a first request transmitted by a second processor to a memory;
performing, by the first processor, at least part of a tensor operation based on the first data and second data stored in the memory to generate a first output; and
writing, by the first processor, the first output to the memory,
wherein the first processor performs processing closer to the memory than the second processor performs processing.

2. The computer-implemented method of claim 1, wherein the memory comprises a plurality of memory banks, and performing at least part of the tensor operation comprises accessing data from one or more memory banks that are included in the plurality of memory banks and a single memory bank cluster based on a memory bank cluster size specified in a second request from the first processor to the memory.

3. The computer-implemented method of claim 1, wherein performing, by the first processor, at least part of the tensor operation comprises, in response to determining that padding needs to be added for a generated memory address, generating, by the first processor, a zero, without reading data stored in the memory at the generated memory address.

4. The computer-implemented method of claim 1, wherein performing, by the first processor, at least part of the tensor operation comprises, in response to determining that padding does not need to be added for a generated memory address, transmitting, by the first processor to the memory, a second request to read data stored in the memory at the generated memory address.

5. The computer-implemented method of claim 1, wherein the tensor operation is one of a LayerNorm operation, a pooling operation, a depthwise convolution operation, a shuffle operation, or an upsampling operation.

6. The computer-implemented method of claim 1, wherein performing, by the first processor, at least part of the tensor operation comprises determining, by the first processor and using a configuration memory, one or more operations to perform and one or more memory addresses in the memory to access.

7. The computer-implemented method of claim 1, wherein the first request is a write request.

8. The computer-implemented method of claim 1, further comprising:
receiving, by the first processor, third data from a second request transmitted by the second processor to the memory; and
performing, by the first processor, an atomic operation based on the third data and fourth data stored in the memory to generate a second output.

9. The computer-implemented method of claim 1, further comprising:
performing, by the first processor, at least part of another tensor operation based on the first data and third data stored in the memory to generate a second output, wherein one or more first instructions associated with the tensor operation and one or more second instructions associated with the another tensor operation are stored sequentially from a base address location in the memory; and
writing, by the first processor, the second output to the memory.

10. The computer-implemented method of claim 1, wherein the second processor comprises an artificial intelligence (AI) accelerator.

11. An integrated circuit comprising:
a memory;
a first processor configured to:
receive first data from a first request,
perform at least part of a tensor operation based on the first data and second data stored in the memory to generate a first output, and
write the first output to the memory, and
a second processor configured to issue the first request to the memory,
wherein the first processor performs processing closer to the memory than the second processor performs processing.

12. The integrated circuit of claim 11, wherein the memory comprises a plurality of memory banks, and performing at least part of the tensor operation comprises accessing data from one or more memory banks that are included in the plurality of memory banks and a single memory bank cluster based on a memory bank cluster size specified in a second request from the first processor to the memory.

13. The integrated circuit of claim 11, wherein performing, by the first processor, at least part of the tensor operation comprises:
in response to determining that padding needs to be added for a generated memory address, generating, by the first processor, a zero, without reading data stored in the memory at the generated memory address; and
in response to determining that padding does not need to be added for a generated memory address, transmitting, by the first processor to the memory, a second request to read data stored in the memory at the generated memory address.

14. The integrated circuit of claim 13, wherein the first processor is further configured to determine that padding needs to be added for the generated memory address based on the generated memory address being outside one or more dimensions of a layer of a neural network or one or more dimensions of an input activation into the layer of the neural network.

15. The integrated circuit of claim 11, wherein the tensor operation is one of a norm operation, a pooling operation, a depthwise convolution operation, a shuffle operation, or an upsampling operation.

16. The integrated circuit of claim 11, wherein the tensor operation is a LayerNorm operation and performing, by the first processor, at least part of the LayerNorm operation comprises:
computing one or more expectations based on the second data; and
computing a LayerNorm based on the one or more expectations.

17. The integrated circuit of claim 11, wherein performing, by the first processor, at least part of the tensor operation comprises determining, by the first processor and based on a table stored in a configuration memory, one or more operations to perform and one or more memory addresses in the memory to access.

18. The integrated circuit of claim 11, wherein the first request is a request to write data that is output by the second processor to the memory.

19. The integrated circuit of claim 11, wherein the integrated circuit comprises a graphics processing unit (GPU).

20. A system, comprising:
a memory; and
a first processor configured to:
receive first data from a first request,
perform at least part of a tensor operation based on the first data and second data stored in the memory to generate a first output, and
write the first output to the memory, and
a second processor configured to issue the first request to the memory,
wherein the first processor performs processing closer to the memory than the second processor performs processing.
